(19) United States
(12) Patent Application Publication
(10) Pub. No.: US 2026/0097707 A1
(43) Pub. Date: Apr. 9, 2026

(54) EXTENDED LATERAL VIEW SYSTEM

(71) Applicant: Ford Global Technologies, LLC, Dearborn, MI (US)

(72) Inventors: LUIS FERNANDO FRAGOSO TRINIDAD, Benito Juárez Norte Xalostoc (MX); Jose David Pena Gonzalez, Cuautitlan Izcalli (MX); David Diaz, Calimaya (MX); JOSE CARLOS BARRERA OVIEDO, Coyoacan (MX)

(21) Appl. No.: 18/907,762

(22) Filed: Oct. 7, 2024

(51) Int. Cl. B60R 1/02; B60Q 1/34; B60R 1/072; B60K 35/10

(52) U.S. Cl. CPC B60R 1/025; B60Q 1/343; B60R 1/072; B60K 35/10; B60K 2360/11; B60K 2360/128

(57) ABSTRACT

A method and a system include a turn signal stalk that is moveable between a neutral position, a standard turn signal position, and a mirror extended view position. A desired extended view position for a mirror is set by a driver, and in accordance with movement of the turn signal stalk to the mirror extended view position, the mirror is automatically moved to the desired extended view position.

### TECHNICAL FIELD

This disclosure relates generally to a mirror system that provides for an extended view option that allows a driver to expand a lateral mirror view for merging purposes.

### BACKGROUND

Vehicles often include side mirrors that are used to facilitate driving maneuvers such as merging, lane changes, parking, etc.

### SUMMARY

A system according to an exemplary aspect of the present disclosure includes, among other things: an input to select between vehicle settings comprising at least a standard view and an extended view; a mirror adjustment control, wherein in accordance with a selection of the extended view, the mirror adjustment control is selectively actuated by a user to position a mirror in a desired extended view position; a turn signal stalk moveable between a standard position and an extended view position; and a controller, wherein in accordance with a selection of the extended view and movement of the turn signal stalk to the extended view position, the controller automatically moves the mirror to the desired extended view position.

In a further non-limiting embodiment of any system, the turn signal stalk is selectively moved to the extended view position in response to the user determining that an extended lateral view may facilitate a driving maneuver.

In a further non-limiting embodiment of any system, the mirror returns from the desired extended view position to a mirror standard position once the driving maneuver has been completed and/or a predetermined condition has been satisfied.

In a further non-limiting embodiment of any system, the user makes a determination of whether an extended lateral view is required in response to movement of the turn signal stalk to the standard position.

In a further non-limiting embodiment of any system, the turn signal stalk returns to a neutral position once the driving maneuver has been completed.

In a further non-limiting embodiment of any system, the neutral position comprises a no turn signal condition, the standard position comprises a right or left turn signal condition, and the extended view position comprises a mirror activation condition to move the mirror to the desired extended view position.

In a further non-limiting embodiment of any system, a memory stores the desired extended view position of the mirror selected by the user.

In a further non-limiting embodiment of any system, the input comprises an input screen with a menu including the vehicle settings.

In a further non-limiting embodiment of any system, the input screen includes a save option that is selectable by the user once the user has moved the mirror to the desired extended view position.

In a further non-limiting embodiment of any system, a button or switch is selectively actuatable by the user to save the mirror in the desired extended view position.

A method according to an exemplary aspect of the present disclosure includes, among other things: providing a turn signal stalk moveable between a neutral position, a standard turn signal position, and a mirror extended view position; setting a desired extended view position for a mirror; and in accordance with movement of the turn signal stalk to the mirror extended view position, automatically moving the mirror to the desired extended view position.

In a further non-limiting embodiment of any method, the method includes: selecting an extended view option from a plurality of vehicle setting options; in accordance with a selection of the extended view option, selectively actuating a mirror adjustment control to set the mirror in the desired extended view position; storing the desired extended view position in memory; and in accordance with a selection of the extended view option and movement of the turn signal stalk to the mirror extended view position, automatically moving the mirror from an initial mirror position to the desired extended view position.

In a further non-limiting embodiment of any method, the method includes selectively moving the turn signal stalk to the mirror extended view position in response to a driver determination that an extended lateral view may facilitate a driving maneuver.

In a further non-limiting embodiment of any method, the method includes automatically returning the mirror from the desired extended view position to the initial mirror position once the driving maneuver has been completed and/or a predetermined condition has been satisfied.

In a further non-limiting embodiment of any method, a driver makes a determination of whether an extended lateral view is required in response to movement of the turn signal stalk to the standard turn signal position.

In a further non-limiting embodiment of any method, the neutral position comprises a no turn signal condition, the standard turn signal position comprises a right or left turn signal condition, and the mirror extended view position comprises a mirror activation condition to initiate movement of the mirror to the desired extended view position, and the method includes returning the turn signal stalk to the neutral position once the driving maneuver has been completed.

In a further non-limiting embodiment of any method, selecting the extended view option from the plurality of vehicle setting options includes selectively interacting with an input screen with a menu including the plurality of vehicle setting options.

In a further non-limiting embodiment of any method, the input screen includes a save option that is selectable by a driver once the mirror has been moved to the desired extended view position.

In a further non-limiting embodiment of any method, the method includes providing a button or switch that is selectively actuatable by a driver to save the mirror in the desired extended view position.

In a further non-limiting embodiment of any method, the method includes locating the button or switch adjacent to the mirror adjustment control.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 is a schematic illustration of a mirror control system for selectively providing an extended lateral view for a mirror.

FIG. 2A is a perspective view of a vehicle interior with a steering wheel, turn signal stalk, and input screen

FIG. 2B is schematic illustration of a plurality of positions for the turn signal stalk.

FIG. 3 is a flow diagram of a procedure for selecting and setting up an extended lateral view option.

FIG. 4A is a perspective view of a mirror in an initial, e.g., standard, view position.

FIG. 4B is similar to FIG. 4A but shows the mirror in the extended lateral view position.

FIG. 5 is a perspective view of an input screen for selecting an extended view option.

FIG. 6 is a top view of a mirror adjustment input.

FIG. 7 is similar to FIG. 5 but shows a save feature for the mirror adjustment setting that provides the extended lateral view.

FIG. 8 is similar to FIG. 6 but shows a button/switch option that is actuated as a save feature for the mirror adjustment setting that provides the extended lateral view.

FIG. 9 is a schematic view of a save message being displayed to a driver once the mirror adjustment setting that provides the extended lateral view has been saved.

FIG. 10 is a flow diagram of an operational example for the mirror control system for selectively providing the extended lateral view.

### DETAILED DESCRIPTION

This disclosure is directed to a mirror system that provides for an extended view option that allows a driver to expand a lateral mirror view for purposes such as merging, for example.

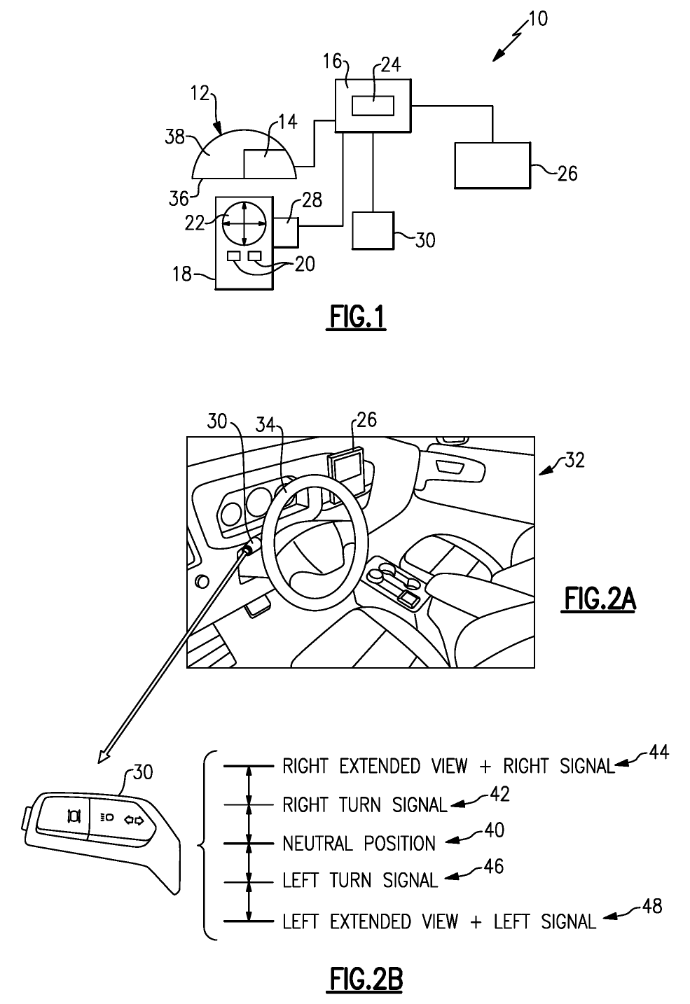

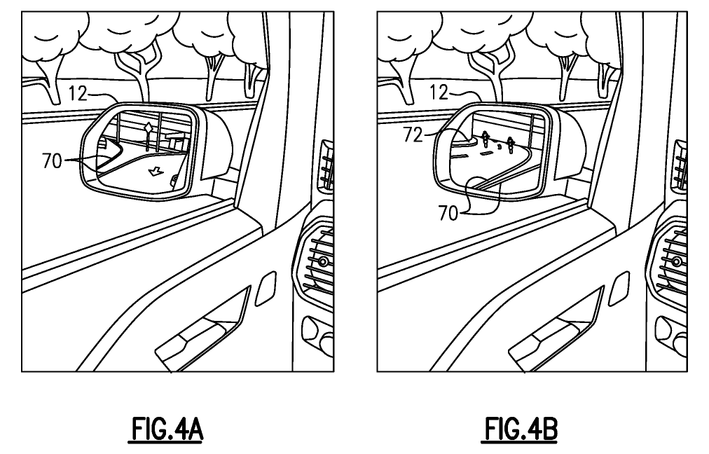

FIG. 1 shows a mirror control system 10 for selectively providing an extended lateral view for a vehicle side/wing mirror 12 with a mirror adjustment control 14 that is controlled by one or more system controllers 16. A mirror adjustment input device 18 includes one or more buttons/switches 20 for selecting a RH or LH side mirror 12, and one or more buttons/switches 22 for adjusting a position of the selected mirror 12. The buttons/switches 22 are actuated by a driver to place the selected mirror 12 in a desired extended lateral view position (compare FIGS. 4A (initial position) and FIG. 4B (extended lateral view position)). Once the selected mirror 12 is in the desired extended lateral view position, the position is saved in memory 24 via either a digital input screen 26 or via a physical button/switch 28. When the extended lateral view option is selected and stored by a driver, a turn signal stalk 30 is selectively controlled by the driver to move the mirror 12 to the desired extended lateral view position when needed.

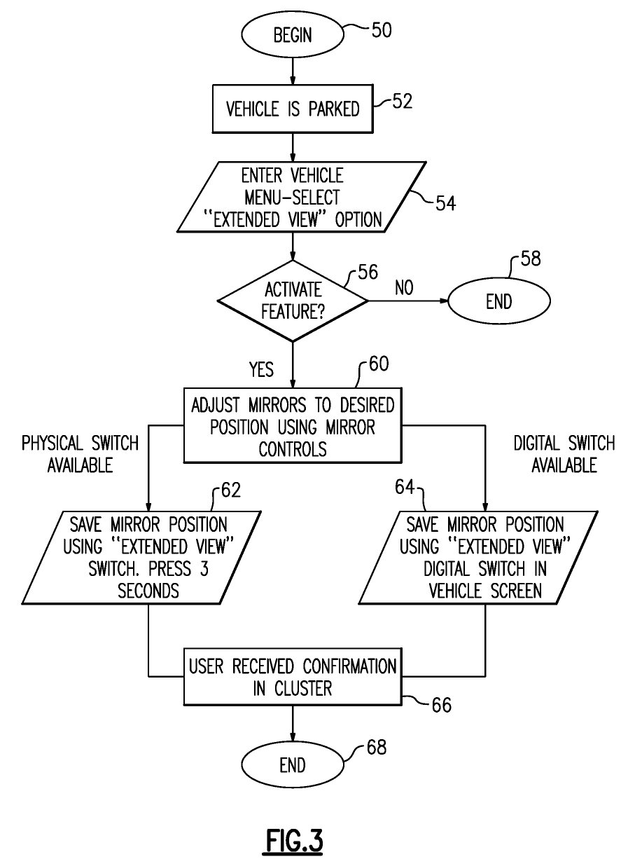

As shown in FIG. 2A, a vehicle 32 includes a driver area with a steering wheel 34, turn signal stalk 30, and input screen 26. In implementations, the input screen 26 can comprise a touch screen or other similar type of electronic display device. The input screen 26 allows a driver to select between a plurality of vehicle settings or options. In one example, the plurality of options includes an option for having an extended lateral view for the side mirror 12. Each mirror 12 includes a mirror adjustment control 14 that can change a position of a mirror surface 36 relative to a mirror housing 38 (FIG. 1). The mirror adjustment control 14 can comprise any type of mirror actuator device such as a motor, gear drive, linear actuator, or any other similar device capable of controlling mirror movement.

In implementations, the mirror surface 36 is moveable between a plurality of different positions, and includes at least a first or initial position and an extended lateral view position that increases a viewing angle for purposes such as merging, for example.

In implementations, and in accordance with a selection of the extended view option from the input screen 26, the mirror adjustment control 14 is selectively actuated by a user to position the mirror surface 36 in a desired extended view position. This position may then be saved in memory 24.

In implementations, the turn signal stalk 30 is moveable between a plurality of positions including at least a neutral position, a standard turn signal position, and a mirror extended view position. FIG. 2B shows an example, where the turn signal stalk 30 is moveable between a neutral position 40, a right turn signal position 42, a right extended lateral view and right signal position 44, a left turn signal position 46, and a left extended lateral view and right signal position 48.

FIG. 3 shows one example of a flow diagram for a procedure for selecting and setting up an extended lateral view option. The procedure begins at 50, while the vehicle 32 is parked as indicated at 52. Next, the driver enters the vehicle 32 and selects the “Extended View” option from a menu on the input screen 26 as indicated at 54. Next, the system determines whether the “Extended View” option has been activated at 56, and if not activated the procedure ends at 58.

If the “Extended View” option is activated, the driver then adjusts the mirror position using the mirror adjustment control 18, as indicated at 60, to a desired extended lateral view position. This desired extended lateral view position can then be saved either by a switch or button as indicated at 62, and/or can be saved by selecting a save option on the input screen 26 as indicated at 64. The driver will then receive a confirmation message as indicated at 66 and the procedure ends at 68.

FIG. 4A shows an example of a starting or initial view for the mirror 12 during a driving maneuver that comprises a merging event. In this view it can be seen that there are two lane lines 70 that are at the far left side of the mirror 12. FIG. 4B shows the same mirror 12 when in the extended lateral view position. In this position, it can be seen that the two lane lines 70 are moved farther to the right and an additional lane line 72, not previously viewable, can now be seen on the left.

To move the mirror 12 to the extended lateral view position, the extended view option must be activated and the turn signal stalk 30 must first be moved to a first turn signal position, e.g., a right turn 42 or left turn 46 signal position. When the turn signal stalk 30 is in this first position, the driver determines whether the lateral view of the mirror should be extended. Once the determination is made that an extended lateral view may facilitate a driving maneuver, the driver selectively moves the turn signal stalk to a second position, e.g.. an extended lateral view and right or left signal position 44, 48.

In implementations, in accordance with a selection of the extended view option and movement of the turn signal stalk 30 to the extended view position, e.g., the second position, the controller 16 automatically moves the mirror 12 to the desired extended lateral view position.

In implementations, the mirror 12 returns from the desired extended view position to a mirror standard or initial position once the driving maneuver has been completed, and/or a predetermined condition has been satisfied. Examples of predetermined conditions may include a steering wheel returning to an original position, a return of the signal stalk to a neutral position, or other similar event.

In implementations, the turn signal stalk 30 returns to the neutral position 40 once the driving maneuver has been completed.

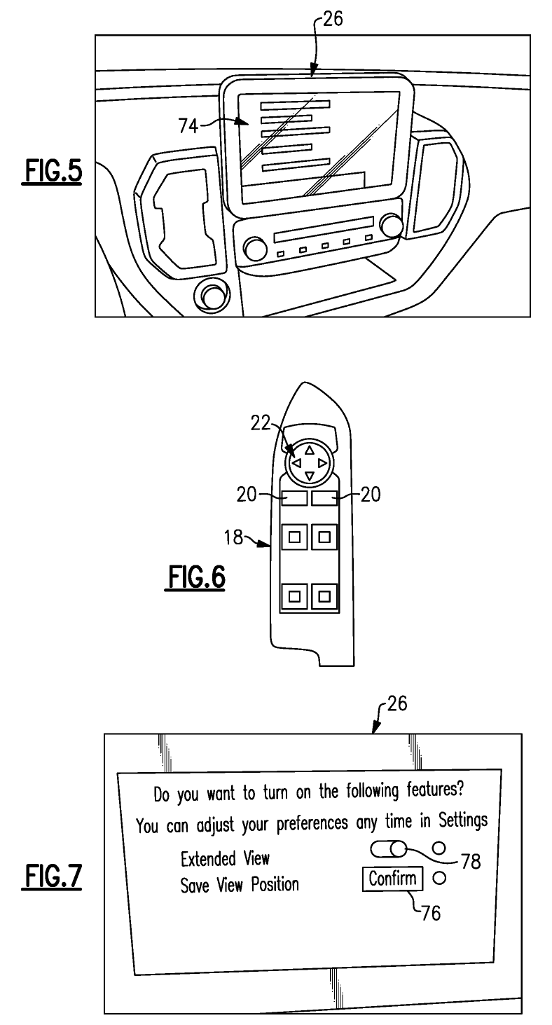

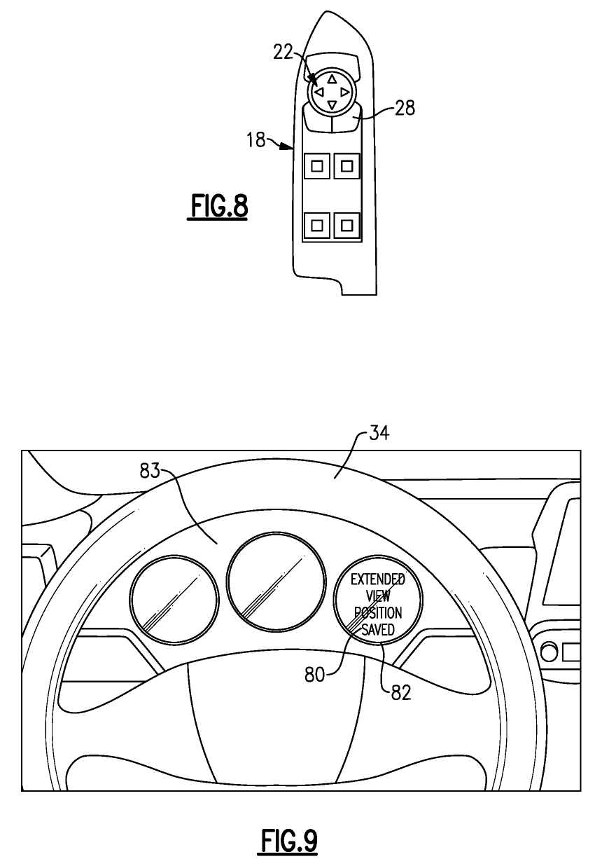

FIG. 5 shows an example of the input device having a menu 74 with a plurality of vehicle settings and options, including an option for mirror extended view 78 (FIG. 7).

FIG. 6 shows an example of the mirror adjustment input 18 with the one or more buttons/switches 20 for selecting a RH or LH side mirror 12, and the one or more buttons/switches 22 for adjusting a position of the selected mirror 12. The buttons/switches 22 are actuated by the driver to place the selected mirror 12 in a desired extended lateral view position.

In implementations, once the selected mirror 12 is in the desired extended lateral view position, the position is saved in memory 24 via either the digital input screen 26 or via the physical button/switch 28.

FIG. 7 shows an example where the input screen 26 includes a save option 76 that is selectable by the driver once the driver has moved the mirror 12 to the desired extended view position.

FIG. 8 shows the button or switch 28 that is selectively actuatable by the driver to save the mirror 12 in the desired extended view position. In one example, to save the desired position, the switch 28 is held down for a predetermined amount of time, e.g. 3 seconds. In implementations, the button or switch 28 may be located adjacent to, may be part of, the mirror adjustment control 18.

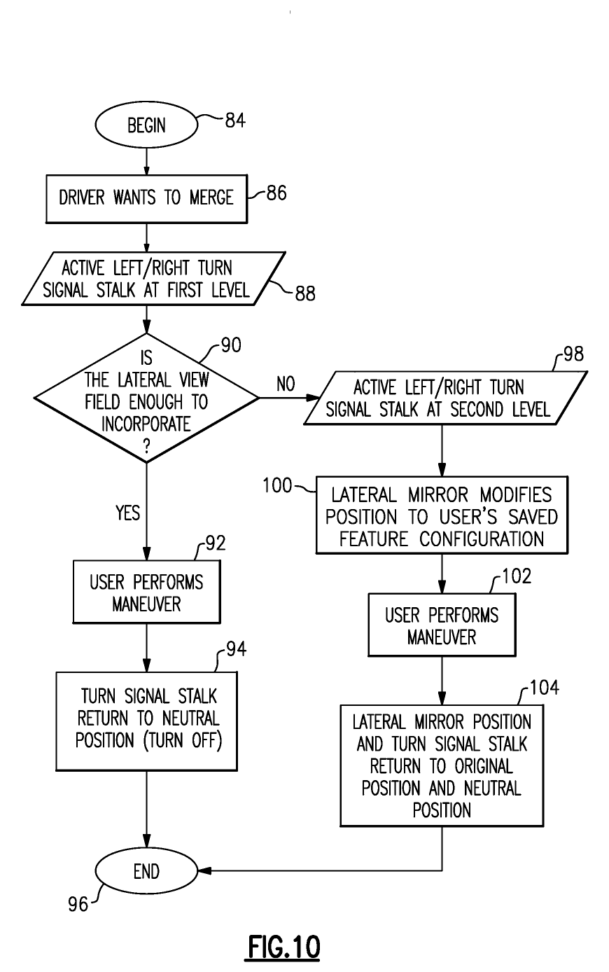

FIG. 9 shows an example where, once the extended view mirror position has been saved, a confirmation message 80 is generated on a screen 82 on an instrument cluster 83, for example.

FIG. 10 is a flow diagram of an operational example for the mirror control system 20 for selectively providing the extended lateral view. The procedure begins at 84, where a driver wants to perform a driving maneuver, e.g., a merging maneuver, as indicated at 86. To initiate this maneuver, the driver moves the turn signal stalk 30 to the appropriate first position 42 or 46, as indicated at 88. Next, the driver makes a determination as to whether the lateral view field (FIG. 4A) is sufficient, as indicated at 90.

If the lateral view field is sufficient, the driver performs the maneuver as indicated at 92, the turn signal stalk 30 returns to the neutral position 40 as indicated at 94, and the operation ends 96. In one example, the turn signal stalk 30 returns to the neutral position 40 when the steering wheel 34 returns to a straight line path; however, the driver may return the stalk to the neutral position, or other methods can be used.

If the lateral view field is not sufficient, the driver moves the turn signal stalk 30 to the appropriate second position 44 or 48, as indicated at 98. The controller 16 then automatically moves the mirror surface 36 to the saved lateral extended view position (FIG. 4B) as indicated at 100. The driver then performs the maneuver as indicated at 102. Once the maneuver is completed, the mirror position and turn signal stalk 30 return to the original position and neutral position 40 as indicated at 104, and the operation ends 96.

In some traditional mirror configurations, due to geometric limitations, exterior mirrors may not be able to provide a complete side/rear view for drivers merging into streets, freeways/highways, etc. The subject disclosure provides for a mirror control system the expands the side/rear view such that merging maneuvers can be more easily performed. Further, the system can be easily and effectively incorporated into any type of vehicle.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A system, comprising:
an input to select between vehicle settings comprising at least a standard view and an extended view;
a mirror adjustment control, wherein in accordance with a selection of the extended view, the mirror adjustment control is selectively actuated by a user to position a mirror in a desired extended view position;
a turn signal stalk moveable between a standard position and an extended view position; and
a controller, wherein in accordance with a selection of the extended view and movement of the turn signal stalk to the extended view position, the controller automatically moves the mirror to the desired extended view position.

2. The system of claim 1, wherein the turn signal stalk is selectively moved to the extended view position in response to the user determining that an extended lateral view may facilitate a driving maneuver.

3. The system of claim 2, wherein the mirror returns from the desired extended view position to a mirror standard position once the driving maneuver has been completed and/or a predetermined condition has been satisfied.

4. The system of claim 2, wherein the user makes a determination of whether an extended lateral view is required in response to movement of the turn signal stalk to the standard position.

5. The system of claim 2, wherein the turn signal stalk returns to a neutral position once the driving maneuver has been completed.

6. The system of claim 5, wherein the neutral position comprises a no turn signal condition, the standard position comprises a right or left turn signal condition, and the extended view position comprises a mirror activation condition to move the mirror to the desired extended view position.

7. The system of claim 1, including a memory to store the desired extended view position of the mirror selected by the user.

8. The system of claim 7, wherein the input comprises an input screen with a menu including the vehicle settings.

9. The system of claim 8, wherein the input screen includes a save option that is selectable by the user once the user has moved the mirror to the desired extended view position.

10. The system of claim 8, including a button or switch that is selectively actuatable by the user to save the mirror in the desired extended view position.

11. A method comprising:
providing a turn signal stalk moveable between a neutral position, a standard turn signal position, and a mirror extended view position;
setting a desired extended view position for a mirror; and
in accordance with movement of the turn signal stalk to the mirror extended view position, automatically moving the mirror to the desired extended view position.

12. The method of claim 11, including:
selecting an extended view option from a plurality of vehicle setting options;
in accordance with a selection of the extended view option, selectively actuating a mirror adjustment control to set the mirror in the desired extended view position;
storing the desired extended view position in memory; and
in accordance with a selection of the extended view option and movement of the turn signal stalk to the mirror extended view position, automatically moving the mirror from an initial mirror position to the desired extended view position.

13. The method of claim 12, including selectively moving the turn signal stalk to the mirror extended view position in response to a driver determination that an extended lateral view may facilitate a driving maneuver.

14. The method of claim 13, including automatically returning the mirror from the desired extended view position to the initial mirror position once the driving maneuver has been completed and/or a predetermined condition has been satisfied.

15. The method of claim 13, wherein a driver makes a determination of whether an extended lateral view is required in response to movement of the turn signal stalk to the standard turn signal position.

16. The method of claim 13, wherein the neutral position comprises a no turn signal condition, the standard turn signal position comprises a right or left turn signal condition, and the mirror extended view position comprises a mirror activation condition to initiate movement of the mirror to the desired extended view position, and including returning the turn signal stalk to the neutral position once the driving maneuver has been completed.

17. The method of claim 12, wherein selecting the extended view option from the plurality of vehicle setting options includes selectively interacting with an input screen with a menu including the plurality of vehicle setting options.

18. The method of claim 17, wherein the input screen includes a save option that is selectable by a driver once the mirror has been moved to the desired extended view position.

19. The method of claim 17, including providing a button or switch that is selectively actuatable by a driver to save the mirror in the desired extended view position.

20. The method of claim 19, including locating the button or switch adjacent to the mirror adjustment control.
